(19) United States
(12) Patent Application Publication
(10) Pub. No.: US 2026/0040166 A1
(43) Pub. Date: Feb. 5, 2026

(54) METHOD AND APPARATUS OF TRANSMITTING MEASUREMENT RECONFIGURATION MESSAGE

(71) Applicant: Beijing Xiaomi Mobile Software Co., Ltd., Beijing (CN)

(72) Inventors: Shuang ZHAO, Beijing (CN); Xing YANG, Beijing (CN)

(73) Assignee: Beijing Xiaomi Mobile Software Co., Ltd., Beijing (CN)

(21) Appl. No.: 18/998,058

(22) PCT Filed: Jul. 25, 2022
(86) PCT No.: PCT/CN2022/107717

§ 371 Date: Jan. 23, 2025

(51) Int. Cl. H04W 36/00

(52) U.S. Cl. CPC H04W 36/0094; H04W 36/0058

(57) ABSTRACT

A method of transmitting a measurement reconfiguration message, including: transmitting indication information to a network device, wherein the indication information is configured to indicate that at least one of an uplink grant resource or a downlink grant resource is insufficient; and receiving the measurement reconfiguration message transmitted by the network device, where the measurement reconfiguration message includes a measurement event A7 for switching a cell.

### CROSS-REFERENCE TO RELATED APPLICATIONS

The present application is a U.S. National Stage of International Application No. PCT/CN2022/107717, filed on Jul. 25, 2022, the contents of all of which are incorporated herein by reference in their entireties for all purposes.

### BACKGROUND OF THE INVENTION

In a wireless communication network, although the quality of a serving cell currently accessed by a terminal device is good, the communication network may experience insufficient uplink or downlink resource scheduling. Due to the quality of the serving cell is good, cell switching cannot be performed, causing the terminal device is in a hanging state in a current serving cell.

### SUMMARY OF THE INVENTION

The present disclosure relates to the technical field of communication, in particular to a method and device of transmitting a measurement reconfiguration message.

In a first aspect, a method of transmitting a measurement reconfiguration message is provided in an embodiment of the present disclosure. The method includes: transmitting indication information to a network device, where the indication information is configured to indicate that at least one of an uplink grant resource or a downlink grant resource configured by the network device is insufficient; and receiving the measurement reconfiguration message transmitted by the network device, where the measurement reconfiguration message includes a measurement event A7 for switching a cell.

In a second aspect, another method of transmitting a measurement reconfiguration message is provided in an embodiment of the present disclosure. The method includes: receiving indication information transmitted by a terminal device, where the indication information is configured to indicate that at least one of an uplink grant resource or a downlink grant resource configured by the network device is insufficient; and transmitting the measurement reconfiguration message to the terminal device, where the measurement reconfiguration message includes a measurement event A7 for switching a cell.

In a third aspect, a communication device is provided in an embodiment of the present disclosure, including one or more processors and a memory, where the memory stores a computer program and the computer program stored in the memory, when collectively executed by the one or more processors, causes the communication device to: transmit indication information to a network device, wherein the indication information is configured to indicate that at least one of an uplink grant resource or a downlink grant resource configured by the network device is insufficient; and receive a measurement reconfiguration message transmitted by the network device, wherein the measurement reconfiguration message comprises a measurement event A7 for switching a cell.

In a fourth aspect, a communication device is provided in an embodiment of the present disclosure, including one or more processors and a memory, where the memory stores a computer program, and the computer program stored in the memory, when collectively executed by the one or more processors, causes the communication device to perform the method described in the second aspect.

In a fifth aspect, a communication device is provided in an embodiment of the present disclosure, including one or more processors and an interface circuit, where the interface circuit is configured to receive code instructions and transmit the code instructions to the one or more processors, and the one or more processors are configured to collectively execute the code instructions to cause the communication device to perform the method described in the first aspect.

In a sixth aspect, a communication device is provided in an embodiment of the present disclosure, including one or more processors and an interface circuit, where the interface circuit is configured to receive code instructions and transmit the code instructions to the one or more processors, and the one or more processors are configured to collectively execute the code instructions to cause the communication device to perform the method described in the second aspect.

In a seventh aspect, a non-transitory computer-readable storage medium is provided in an embodiment of the present disclosure, stores instructions for the terminal device, where the instructions, when executed, cause the terminal device to perform the method described in the first aspect.

### BRIEF DESCRIPTION OF DRAWINGS

In order to explain the technical solutions in the embodiments or background of the present disclosure more clearly, the drawings needed in the embodiments or background of the present disclosure will be explained hereinafter.

FIG. 1 is a schematic architecture diagram of a communication system according to an embodiment of the present disclosure.

FIG. 2 is a flowchart of a method of transmitting a measurement reconfiguration message according to an embodiment of the present disclosure.

FIG. 3 is a flowchart of another method of transmitting the measurement reconfiguration message according to an embodiment of the present disclosure.

FIG. 4 is a flowchart of another method of transmitting the measurement reconfiguration message according to an embodiment of the present disclosure.

FIG. 5 is a flowchart of another method of transmitting the measurement reconfiguration message according to an embodiment of the present disclosure.

FIG. 6 is a flowchart of another method of transmitting the measurement reconfiguration message according to an embodiment of the present disclosure.

FIG. 7 is a flowchart of another method of transmitting the measurement reconfiguration message according to an embodiment of the present disclosure.

FIG. 8 is a schematic structural diagram of a communication device according to an embodiment of the present disclosure.

FIG. 9 is a schematic structural diagram of another communication device according to an embodiment of the present disclosure.

FIG. 10 is a schematic structural diagram of a chip according to an embodiment of the present disclosure.

### DETAILED DESCRIPTION OF THE INVENTION

Example embodiments will be described in detail herein, examples of which are shown in the drawings. When the following description is made with reference to the s drawings, the same numerals in different drawings represent the same or similar elements unless otherwise indicated. The implementations described in the following example embodiments do not represent all implementations consistent with the present disclosure. Rather, they are merely examples of the device and the method consistent with some aspects of the present disclosure as detailed in the appended claims.

The terms used in the embodiments of the present disclosure are for the purpose of describing specific embodiments only and are not intended to limit the embodiments of the present disclosure. The singular forms “a” and “the” used in the embodiments of the present disclosure are also intended to include the plural forms, unless the context clearly indicates otherwise. It is also to be understood that the term “and/or” as used herein refers to and includes any or all possible combinations of one or more associated listed items.

It is to be understood that although the terms first, second, third, etc. may be used to describe various information in the embodiments of the present disclosure, the information should not be limited by these terms. These terms are merely used to distinguish the same type of information from each other. For example, without departing from the scope of the embodiments of the present disclosure, first information may be referred to as second information, and similarly, the second information may be referred to as the first information. Depending on the context, the word “if” as used herein may be interpreted as “when” or “as” or “in response to determining”. For the purpose of simplicity and easy understanding, the terms used in the present disclosure when representing the relationship of size are “greater than” or “less than”, “higher than” or “lower than”. But for those skilled in the art, it may be understood that the term “greater than” also covers the meaning of “greater than or equal to”, and the term “less than” also covers the meaning of “less than or equal to”; the term “higher than” covers the meaning of “higher than or equal to”, and the term “lower than” also covers the meaning of “lower than or equal to”.

In order to facilitate understanding, the terms involved in the present disclosure are first introduced.

Reference signal received power (RSRP) represents a linear average value of the power contribution of a resource element carrying a cell-specific reference signal within an investigated measurement bandwidth. The RSRP may indicate the “logical distance” between the terminal device and the network device, and may be determined as the input of the decision of switching and cell reselection.

Reference signal receiving quality (RSRQ) represents a receiving quality of a reference signal. The measurement mainly ranks different LTE candidate cells according to the quality of a signal, and the measurement of the RSRQ is determined as the input of the decision of switching and cell reselection.

Signal to Interference plus Noise Ratio (SIRN) represents a ratio of the strength of a received useful signal to the strength of a received interference signal (noise and interference), which may be simply understood as “signal-to-noise ratio” and may be determined as the input of the decision of switching and cell reselection.

Abstract Syntax Notation One (ASN.1) is an ISO/ITU-T standard, which describes a data format of representing, encoding, transmitting and decoding data.

In order to understand a method of transmitting a measurement reconfiguration message disclosed in the embodiment of the present disclosure better, a communication system applicable to the embodiment of the present disclosure will be described hereinafter.

Refer to FIG. 1, which is a schematic architecture diagram of the communication system according to an embodiment of the present disclosure. The communication system may include, but is not limited to, a network device and a terminal device. The number and the form of devices shown in FIG. 1 are merely determined as an example and do not form a limitation to the embodiment of the present disclosure. In the practical application, two or more network devices and two or more terminal devices may be included. The communication system shown in FIG. 1 includes a network device 101 and a terminal device 102 as an example.

It is to be noted that the technical solution of the embodiment of the present disclosure may be applied to various communication systems. For example: a long term evolution (LTE) system, a 5th generation (5G) mobile communication system, a 5G new radio (NR) system, or other new future mobile communication systems. It is also to be noted that a sidelink in the embodiment of the present disclosure may also be referred to as a side link or a direct link.

The network device 101 in the embodiment of the present disclosure is an entity at the network side for transmitting or receiving a signal. For example, the network device 101 may be an evolved nodeB (eNB), a transmission reception point (TRP), a next generation nodeB (gNB) in the NR system, a base station in other future mobile communication systems or an access node in a wireless fidelity (Wi-Fi) system. The embodiment of the present disclosure does not limit the specific technology and the specific device form used by the network device. The network device according to the embodiment of the present disclosure may consist of a central unit (CU) and a distributed unit (DU), where CU may also be referred to as a control unit. With the structure of the CU-DU, protocol layers of the network device, such as the base station, may be separated. Some functions of the protocol layers are placed in the CU for centralized control, while some or all remaining functions of the protocol layers are distributed in the DU, and the CU centrally controls the DU.

The terminal device 102 in the embodiment of the present disclosure is an entity at the user side for receiving or transmitting a signal, such as a mobile phone. The terminal device may also be referred to as a terminal, a user equipment (UE), a mobile station (MS), a mobile terminal (MT), etc. The terminal device may be a car with a communication function, a smart car, a mobile phone, a wearable device, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. The embodiment of the present disclosure does not limit the specific technology and the specific device form used by the terminal device.

In the sidelink communication, there are four sidelink transmission modes. The sidelink transmission mode 1 and the sidelink transmission mode 2 are used for device-to-device (D2D) communication of the terminal device. The sidelink transmission mode 3 and the sidelink transmission mode 4 are used for vehicle-to-everything (V2X) communication. When the sidelink transmission mode 3 is used, resource allocation is scheduled by the network device 101.Specifically, the network device 101 may transmit resource allocation information to the terminal device 102, and then the terminal device 102 may allocate resources to another terminal device, so that the another terminal device may transmit information to the network device 101 through the allocated resources. In V2X communication, a terminal device with the good signal or high reliability may be determined as the terminal device 102. The first terminal device mentioned in the embodiment of the present disclosure may refer to the terminal device 102, and the second terminal device may refer to the another terminal device.

It may be understood that the communication system described in the embodiment of the present disclosure is used to explain the technical solution of the embodiment of the present disclosure more clearly, and does not form a limitation on the technical solution provided by the embodiment of the present disclosure. As those skilled in the art know, with the evolution of the system architecture and the emergence of new service scenarios, the technical solution according to the embodiment of the present disclosure is also applicable to solve similar technical problems.

It is to be noted that a method of transmitting a measurement reconfiguration message according to any embodiment in the present disclosure may be performed alone, or in combination with possible implementation methods in other embodiments, or in combination with any technical solution in related art.

A method and device of transmitting a measurement reconfiguration message are provided in an embodiment of the present disclosure. A network device retransmits a measurement reconfiguration message through indication information indicating that a resource is insufficient, so that a terminal device can perform re-measurement, which provides a basis for the terminal device to switch a cell in the next step, and avoids the problem that the terminal device is in a hanging state.

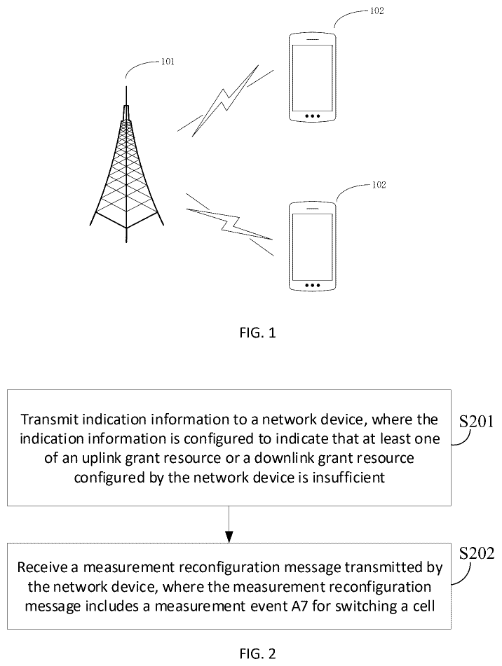

The method and device of transmitting a measurement reconfiguration message according to the present disclosure will be introduced in detail with reference to the drawings hereinafter. Refer to FIG. 2, which is a flowchart of a method of transmitting the measurement reconfiguration message according to an embodiment of the present disclosure. The method of transmitting the measurement reconfiguration message is performed by a terminal device, as shown in FIG. 2. The method includes but is not limited to the following steps.

S201: indication information is transmitted to a network device, where the indication information is configured to indicate that at least one of an uplink grant resource or a downlink grant resource configured by the network device is insufficient.

The terminal device may receive at least one of an uplink grant resource or the downlink grant resource configured by the network device. Alternatively, the terminal device may receive at least one of the uplink grant resource or the downlink grant resource from the network device through a radio resource control (RRC) message or other message.

In a case where the terminal device needs to perform transmission, a required resource for the transmission may be determined. Further, the required resource is compared with a resource granted by the network device for the terminal device. In a case where the required resource for the transmission is less than the resource granted by the network device for the terminal device, the transmission may be directly performed. However, in a case where the required resource for the transmission exceeds the resource granted by the network device for the terminal device, it may be determined that the grant resource configured by the network device is insufficient.

In some implementations, in a case where the terminal device needs to transmit data, a required resource for transmission may be determined. Further, the required resource for the transmission is compared with the uplink grant resource. In a case where the required resource for transmission exceeds the uplink grant resource, the indication information indicating that the uplink grant resource is insufficient may be transmitted to the network device.

In other implementations, in a case where the terminal device needs to receive data, a required resource for receiving data may be determined. Further, the required resource for receiving data is compared with the downlink grant resource. In a case where the required resource for reception exceeds the downlink grant resource, the indication information indicating that the downlink grant resource is insufficient may be transmitted to the network device.

In other implementations, in a case where the terminal device needs to send and receive data, the required resource for transmission is compared with the uplink grant resource, and the required resource for reception is compared with the downlink grant resource. If the required resource for transmission exceeds the uplink grant resource, and the required resource for reception exceeds the downlink grant resource, the indication information indicating that both the uplink grant resource and the downlink grant resource are insufficient may be transmitted to the network device.

S202: a measurement reconfiguration message transmitted by the network device is received, where the measurement reconfiguration message includes a measurement event A7 for switching a cell.

In the embodiment of the present disclosure, the terminal device transmits the indication information indicating that a resource is insufficient to the network device, meaning that a resource of the source serving cell currently accessed by the terminal device is insufficient. In order to enable the contact state between the terminal device and the network to be optimal, and then provide guarantee for the application of various network services, the terminal device needs to perform cell switching in mobility management, that is to say, the terminal device completes the migration of the wireless link connection from the source serving cell to the target serving cell under the control of the wireless access network.

After receiving the indication information indicating that at least one of the uplink grant resource or the downlink grant resource is insufficient, the network device may transmit a measurement reconfiguration message to the terminal device, so that the terminal device may re-measure a nearby cell. In the embodiment of the present disclosure, a measurement event A7 may be added to the measurement reconfiguration message, and the purpose of cell switching may be achieved through the measurement event A7. It is to be noted that the measurement event A7 is an event defined in the present disclosure, which is configured to measure cells with the same frequency or different frequencies and measure the signal quality of a new cell to which the terminal device moves to a service bearer switching.

Alternatively, the measurement event A7 may include a condition that triggers a measurement report (MR), for example, may include a measurement object that needs to be measured in a serving cell and a candidate serving cell, and the relationship between a measurement value of a measurement object of the serving cell and a measurement value of a measurement object of the candidate serving cell.

Alternatively, the measurement object may include at least one of the RSRP, the RSRQ or the SINR of the cell.

It is to be noted that the premise of cell switching is to measure the signal quality of the source serving cell and the candidate serving cell of the terminal device. After receiving the measurement reconfiguration message, the terminal device may re-measure the signal quality of the source serving cell and the candidate serving cell based on the measurement reconfiguration message, to select a target serving cell with better signal quality for the terminal device from the candidate serving cell.

In the embodiment of the present disclosure, there may be one or more candidate serving cells of the terminal device. Alternatively, the candidate serving cell may be a neighbor cell of the source serving cell. Alternatively, the candidate serving cell may use the same radio frequency (RF) carrier frequency as the currently accessed source serving cell. Alternatively, the candidate serving cell may use a different RF carrier frequency from the source serving cell. In some implementations, the candidate serving cell and the source serving cell may belong to the same base station. Alternatively, the candidate serving cell and the source serving cell may not belong to the same base station. This is not limited in the embodiment of the present disclosure.

Alternatively, the candidate serving cell may be indicated to the terminal device by the network device. For example, the terminal device may receive indication information, which carries a cell ID, an index or a cell ID offset of the candidate serving cell. For example, the indication information may carry a cell list, which includes the cell ID, the index or the cell ID offset of the candidate serving cell.

Alternatively, the terminal device performs layer 1 (L1) measurement on the source serving cell and the candidate serving cell. Alternatively, the terminal device performs L2 measurement on the source serving cell and the candidate serving cell. Alternatively, the terminal device performs L3 measurement on the source serving cell and the candidate serving cell. This is not limited in the embodiment of the present disclosure.

Alternatively, the terminal device may measure at least two measurement objects from the RSRP, the RSRQ and the SINR of the source serving cell. Correspondingly, the terminal device may measure at least two measurement objects from the RSRP, the RSRQ and the SINR of the candidate serving cell. The at least two measurement objects may be indicated in the measurement event A7 or agreed by a protocol.

In the embodiment of the present disclosure, in response to determining that at least one of the uplink grant resource or the downlink grant resource is insufficient, the indication information may be transmitted to the network device, and the measurement reconfiguration message transmitted by the network device may be received. The measurement reconfiguration message includes the measurement event A7 for switching the cell. In the embodiment of the present disclosure, the network device retransmits the measurement reconfiguration message through the indication information indicating that the resource is insufficient, so that the terminal device can perform re-measurement quickly, which may solve the problem that re-measurement cannot be performed due to the insufficient resource though the quality of the terminal device is good, provide a basis for the terminal to switch the cell in the next step, and avoid the problem that the terminal device is in a hanging state.

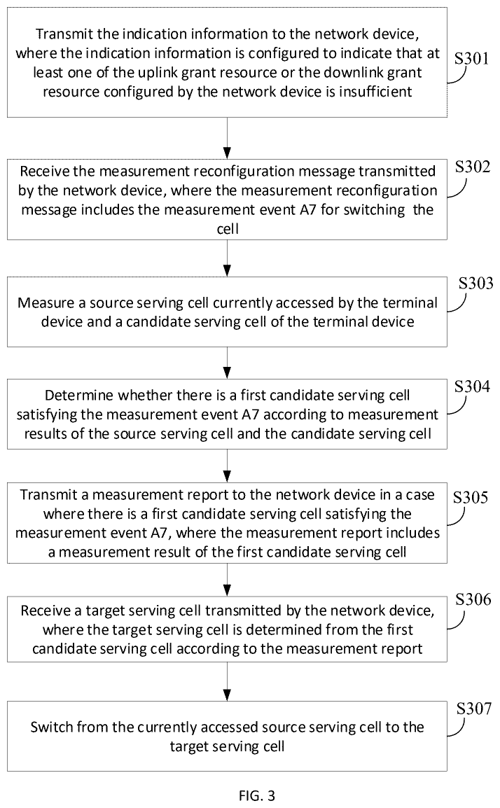

Refer to FIG. 3, which is a flowchart of a method of transmitting the measurement reconfiguration message according to an embodiment of the present disclosure. The method of transmitting the measurement reconfiguration message is performed by the terminal device, as shown in FIG. 3. The method includes but is not limited to the following steps.

S301: the indication information is transmitted to the network device, where the indication information is configured to indicate that at least one of the uplink grant resource or the downlink grant resource configured by the network device is insufficient.

In some implementations, the indication information is transmitted to the network device through an ASN.1 message body. Alternatively, in response to determining that at least one the uplink grant resource or downlink grant resource is insufficient, the terminal device configures a value of the indication information as a set value, adds the indication information to the ASN.1 message body, and transmits the ASN. 1 message body to the network device. For example, the indication information may be no grant IE. The value of the indication information may be set to true.

For the process that the terminal device detects at least one of the uplink grant resource or the downlink grant resource is insufficient, refer to the description of relevant contents in the above embodiments, which will not be described in detail here.

S302: the measurement reconfiguration message transmitted by the network device is received, where the measurement reconfiguration message includes the measurement event A7 for switching the cell.

In an implementation, the measurement event A7 may include at least one of the following measurement reporting conditions.

First measurement values of at least two measurement objects from the RSRP, the RSRQ and the SINR of the source serving cell need to be less than second measurement values of at least two measurement objects from the RSRP, the RSRQ and the SINR of the candidate serving cell, where the at least two measurement objects of the candidate serving cell are the same as the at least two measurement objects of the source serving cell, that is to say, it is determined that the candidate serving cell satisfies the measurement event A7 in a case where the first measurement values of the at least two measurement objects are less than the respective second measurement values.

For example, in a case where the first measurement values of the RSRP and the RSRQ of the source serving cell are less than the second measurement values of the RSRP and the RSRQ of the candidate serving cell, it is determined that the candidate serving cell satisfies the measurement event A7.

For another example, in a case where the first measurement values of the RSRP and the SIRN of the source serving cell are less than the second measurement values of the RSRP and the SIRN of the candidate serving cell, it is determined that the candidate serving cell satisfies the measurement event A7.

For another example, in a case where the first measurement values of the RSRQ and the SIRN of the source serving cell are less than the second measurement values of the RSRQ and the SIRN of the candidate serving cell, it is determined that the candidate serving cell satisfies the measurement event A7.

Illustratively, the source server cell is a primary cell (Pcell), and the candidate serving cell is a neighbor cell. The above measurement reporting conditions may be expressed as follows.

In the case where Pcell_RSRP<Neighbor cell_RSRP and Pcell_RSRQ<Neighbor cell_RSRQ, it may be determined that the neighbor cell satisfies the measurement event A7.

In the case where Pcell_RSRP<Neighbor cell_RSRP and Pcell_SIRN<Neighbor cell SIRN, it may be determined that the neighbor cell satisfies the measurement event A7.

In the case where Pcell_RSRQ<Neighbor cell_RSRQ and Pcell_SIRN<Neighbor cell SIRN, it may be determined that the neighbor cell satisfies the measurement event A7.

In another implementation, the measurement event A7 may include at least one of the following measurement reporting conditions.

First measurement values of at least two measurement objects from the RSRP, the RSRQ and the SINR of the source serving cell need to be less than respective sum values of the respective second measurement values of the at least two measurement objects and respective offsets of respective measurement objects, where the at least two measurement objects of the candidate serving cell are the same as the at least two measurement objects of the source serving cell, that is to say, it is determined that the candidate serving cell satisfies the measurement event A7 in a case where the first measurement values of the at least two measurement objects are less than the respective sum values.

For example, in the case where the sum values of the second measurement values of the RSRP and the RSRQ of the candidate serving cell and their respective offsets, the first measurement values of the RSRP and the RSRQ of the source serving cell are less than the respective sum values of the respective measurement objects of the candidate serving cell, it may be determined that the candidate serving cell satisfies the measurement event A7.

In the case where Pcell_RSRP <Neighbor cell_RSRP+Offset_RSRP and Pcell_RSRQ<Neighbor cell_RSRQ+Offset_RSRQ, it may be determined that the neighbor cell satisfies the measurement event A7.

For another example, in the case where the sum values of the second measurement values of the RSRP and the SIRN of the candidate serving cell and their respective offsets, the first measurement values of the RSRP and the SIRN of the source serving cell are less than the respective sum values of the respective measurement objects of the candidate serving cell, it may be determined that the candidate serving cell satisfies the measurement event A7.

In the case where Pcell_RSRP<Neighbor cell_RSRP+Offset RSRP and Pcell SIRN<Neighbor cell_SIRN+Offset_SIRN, it may be determined that the neighbor cell satisfies the measurement event A7.

For example, in the case where the sum values of the second measurement values of the RSRQ and the SIRN of the candidate serving cell and their respective offsets, the first measurement values of the RSRQ and the SIRN of the source serving cell are less than the respective sum values of the respective measurement objects of the candidate serving cell, it may be determined that the candidate serving cell satisfies the measurement event A7.

In the case where Pcell_RSRQ<Neighbor cell_RSRQ+Offset RSRP and Pcell SIRN<Neighbor cell_SIRN+Offset_SIRN, it may be determined that the neighbor cell satisfies the measurement event A7.

S303: a source serving cell currently accessed by the terminal device and a candidate serving cell of the terminal device are measured.

It is to be noted that the premise of cell switching is to measure the signal quality of the source serving cell and the candidate serving cell of the terminal device. After receiving the measurement reconfiguration message, the terminal device may re-measure the signal quality of the source serving cell and the candidate serving cell based on the measurement reconfiguration message, to select a target serving cell with better signal quality for the terminal device from the candidate serving cell.

The terminal device may measure at least two measurement objects from the RSRP, the RSRQ and the SINR of the source serving cell. Correspondingly, the terminal device may measure at least two measurement objects from the RSRP, the RSRQ and the SINR of the candidate serving cell. The at least two measurement objects may be indicated by the measurement event A7 or agreed by a protocol.

S304: it is determined whether there is a first candidate serving cell satisfying the measurement event A7 according to measurement results of the source serving cell and the candidate serving cell.

The terminal device may compare the measurement results of the source serving cell and the candidate serving cell according to the measurement event A7. When the measurement results of the candidate serving cell and the source serving cell satisfy the measurement event A7, the candidate serving cell may be determined as the first candidate serving cell satisfying the measurement event A7.

S305: a measurement report is transmitted to the network device in a case where there is a first candidate serving cell satisfying the measurement event A7, where the measurement report includes a measurement result of the first candidate serving cell.

Alternatively, after the first candidate serving cell satisfying the measurement event A7 is determined from the candidate serving cell based on the measurement event A7, the measurement result of the first candidate serving cell may be reported to the network device. The measurement result may indicate the signal strength or the quality of the first candidate serving cell.

The measurement report may include the cell ID of the reported first candidate serving cell and the measurement result of the first candidate serving cell. That is to say, the terminal device may bind the cell ID of the first candidate serving cell satisfying the measurement event A7 with a measurement result corresponding to the first candidate serving cell, which are transmitted to the network device by the terminal device.

In some implementations, the terminal device may transmit the cell ID of each first candidate serving cell satisfying the measurement event A7 and the measurement result corresponding to each first candidate serving cell to the network device. In other implementations, the terminal device may select the first candidate serving cell satisfying the measurement event A7 according to the measurement result, the cell whose measurement result satisfies a preset condition is selected, and the cell ID of the candidate serving cell satisfying the preset condition and a measurement result corresponding to the candidate serving cell are transmitted to the network device. For example, the terminal device may select some candidate serving cells with good quality according to the measurement result, and transmit the cell IDs of the candidate serving cells with good quality and measurement results corresponding to the candidate serving cells to the network device, to reduce signaling overhead and save resources.

Alternatively, in a case where the first candidate serving cell satisfying the measurement event A7 is not determined from the candidate serving cell based on the measurement event A7, the terminal device does not need to report the measurement report to the network device. In this case, the terminal device continues to remain in a currently accessed source serving cell.

The method of transmitting the measurement reconfiguration message according to an embodiment of the present disclosure may further include the following steps.

S306: a target serving cell transmitted by the network device is received, where the target serving cell is determined from the first candidate serving cell according to the measurement report.

Alternatively, a cell switching instruction transmitted by the network device is received, where the cell switching instruction includes a target serving cell, and the target serving cell is a cell determined from the first candidate serving cell satisfying the measurement event A7.

After the terminal device reports the first candidate serving cell satisfying the measurement event A7 and the measurement result of the first candidate serving cell to the network device, the network device may select the candidate serving cell satisfying a switching condition as the target serving cell from the reported first candidate serving cell based on the reported measurement result. For example, the switching condition may include that the cell quality satisfies a requirement and the cell is in an idle state. The network device determines the cell switching instruction according to the target serving cell and transmits the cell switching instruction to the terminal device. Correspondingly, the terminal device receives the cell switching instruction transmitted by the network device, and the cell switching instruction includes a cell ID or an index or an ID offset of the target serving cell. Alternatively, the terminal device may receive the cell switching instruction transmitted by the network device through the RRC, a downlink control information (DCI) or a medium access control-control element (MAC-CE) signaling.

S307: switch from the currently accessed source serving cell to the target serving cell.

After receiving the cell switching instruction, the terminal device may determine the target serving cell that the terminal device needs to access for switching. The terminal device and the network device perform an information interaction process for switch the cell, to achieve the switching from the source serving cell currently accessed by the terminal device to the target serving cell.

Alternatively, if the target serving cell uses the same RF carrier frequency as the currently accessed source serving cell, the switching is performed at the same frequency. Alternatively, if the target serving cell uses a different RF carrier frequency from the source serving cell, the switching is performed at a different frequency.

In a case where the target serving cell and the source serving cell belong to the same base station, cell switching in the base station is performed. In a case where the target serving cell and the source serving cell do not belong to the same base station, cell switching between base stations is performed.

In some implementations, in the process of cell switching, the terminal device may be first disconnected from the source serving cell and then access the target serving cell. In other implementations, in the process of cell switching, the terminal device may maintain the connection with the source serving cell until the terminal device accesses the target serving cell, then the terminal device is disconnected from the source serving cell.

In the embodiment of the present disclosure, in response to determining that at least one of the uplink grant resource or the downlink grant resource is insufficient, indication information may be transmitted to the network device, and the measurement reconfiguration message transmitted by the network device may be received. The measurement reconfiguration message includes the measurement event A7 for switching the cell. In the embodiment of the present disclosure, the network device retransmits the measurement reconfiguration message through the indication information indicating that the resource is insufficient, so that the terminal device can perform re-measurement quickly, which may solve the problem that re-measurement cannot be performed due to the insufficient resource though the quality of the terminal device is good, provide a basis for the terminal device to switch the cell in the next step, and avoid the problem that the terminal device is in a hanging state. Further, the insufficient resource may be quickly indicated to the network device, so that the network device can quickly determine the target serving cell of the terminal device, reduce the switching delay, improve the mobility performance, enable the contact state between the terminal device and the network to be always optimal, and further provide guarantee for the application of various network services.

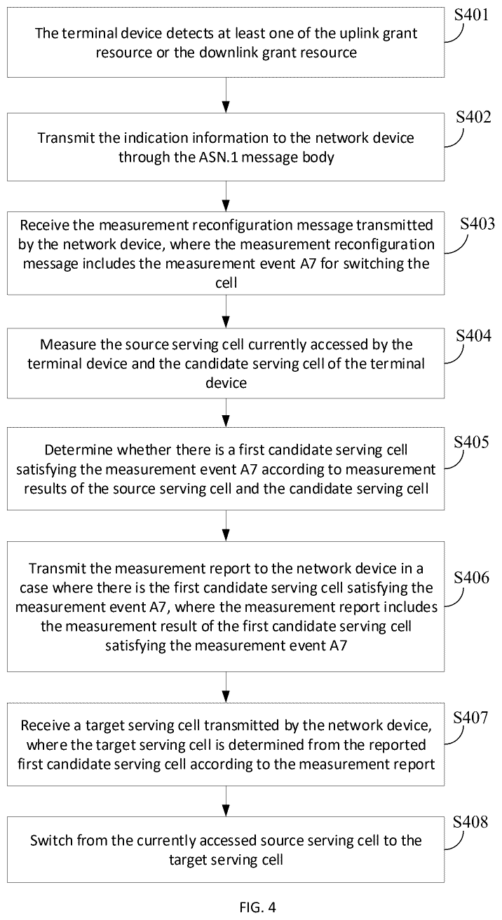

Refer to FIG. 4, which is a flowchart of a method of transmitting the measurement reconfiguration message according to an embodiment of the present disclosure. The method of transmitting the measurement reconfiguration message is performed by the terminal device, as shown in FIG. 4. The method includes but is not limited to the following steps.

S401: the terminal device detects at least one of the uplink grant resource or the downlink grant resource.

Alternatively, at least one of the uplink grant resource or the downlink grant resource configured by the network device is received. The terminal device may determine the required resource for transmission performed by the terminal device. Further, at least one of the uplink grant resource or the downlink grant resource is compared with the required resource to detect whether at least one of the uplink grant resource or the downlink grant resource is sufficient. For the specific detection process, refer to the description of relevant contents in the above embodiments, which will not be described in detail here.

S402: the indication information is transmitted to the network device through the ASN.1 message body.

In response to determining that at least one of the uplink grant resource or the downlink grant resource is insufficient, the indication information may be set as a set value, and added to the ASN.1 message body, the ASN.1 message body is transmitted to the network device.

In response to determining that at least one of the uplink grant resource or the downlink grant resource is sufficient, which means that the quality of the currently accessed source serving cell is good, the terminal device maintains to stay in the source serving cell.

S403: the measurement reconfiguration message transmitted by the network device is received, where the measurement reconfiguration message includes the measurement event A7 for switching the cell.

S404: the source serving cell currently accessed by the terminal device and the candidate serving cell of the terminal device are measured.

S405: it is determined whether there is a first candidate serving cell satisfying the measurement event A7 according to measurement results of the source serving cell and the candidate serving cell.

For the detailed introduction of Step S404 and Step S405, refer to the description of relevant contents in the above embodiments, which will not be described in detail here.

S406: the measurement report is transmitted to the network device in a case where there is the first candidate serving cell satisfying the measurement event A7, where the measurement report includes the measurement result of the first candidate serving cell satisfying the measurement event A7.

Alternatively, the terminal device determines that the candidate serving cell satisfies the measurement event A7, which may include the following steps.

The terminal device determines first measurement values of at least two measurement objects from the RSRP, the RSRQ and the SINR of the source serving cell, and determines second measurement values of at least two measurement objects from the RSRP, the RSRQ and the SINR of the candidate serving cell, where the at least two measurement objects of the candidate serving cell are the same as the at least two measurement objects of the source serving cell. Further, the terminal device may determine that the candidate serving cell satisfies the measurement event A7 in a case where the first measurement values of the at least two measurement objects are less than the respective second measurement values.

Alternatively, the terminal device determines that the candidate serving cell satisfies the measurement event A7, which may include the following steps.

The terminal device determines first measurement values of at least two measurement objects from the RSRP, the RSRQ and the SINR of the source serving cell, and determines second measurement values of at least two measurement objects from the RSRP, the RSRQ and the SINR of the candidate serving cell, wherein the at least two measurement objects of the candidate serving cell are the same as the at least two measurement objects of the source serving cell. Further, the terminal device obtains respective sum values of the respective second measurement values of the at least two measurement objects and respective offsets. The terminal device may determine that the candidate serving cell satisfies the measurement event A7 in a case where the first measurement values of the at least two measurement objects are less than the respective sum value.

In the embodiment of the present disclosure, the terminal device may transmit a measurement report to the network device in response to determining that there is a first candidate serving cell satisfying the measurement event A7 among the candidate serving cell, where the measurement report includes the first candidate serving cell satisfying the measurement event A7 and the measurement result corresponding to the first candidate serving cell. For the process of determining that there is a first candidate serving cell satisfying the measurement event A7 among the candidate serving cell, refer to the description of relevant contents in the above embodiments, which will not be described in detail here.

S407: a target serving cell transmitted by the network device is received, where the target serving cell is determined from the reported first candidate serving cell according to the measurement report.

S408: switch from the currently accessed source serving cell to the target serving cell.

For the detailed introduction of Step S407 and Step S408, refer to the description of relevant contents in the above embodiments, which will not be described in detail here.

In the embodiment of the present disclosure, in response to determining that at least one of the uplink grant resource or the downlink grant resource is insufficient, indication information may be transmitted to the network device, and the measurement reconfiguration message transmitted by the network device may be received. The measurement reconfiguration message includes the measurement event A7 for switching the cell. In the embodiment of the present disclosure, the network device retransmits the measurement reconfiguration message through the indication information indicating that the resource is insufficient, so that the terminal device can perform re-measurement quickly, which may solve the problem that re-measurement cannot be performed due to the insufficient resource though the quality of the terminal device is good, provide a basis for the terminal device to switch the cell in the next step, and avoid the problem that the terminal device is in a hanging state. Further, the insufficient resource may be quickly indicated to the network device, so that the network device can quickly determine the target serving cell of the terminal device, reduce the switching delay, improve the mobility performance, enable the contact state between the terminal device and the network to be always optimal, and further provide guarantee for the application of various network services.

Refer to FIG. 5, which is a flowchart of a method of transmitting the measurement reconfiguration message according to an embodiment of the present disclosure. The method of transmitting the measurement reconfiguration message is performed by the network device, as shown in FIG. 5. The method includes but is not limited to the following steps.

S501: the indication information transmitted by the terminal device is received, where the indication information is configured to indicate that at least one of the uplink grant resource or the downlink grant resource configured by the network device is insufficient.

The terminal device may receive at least one of the uplink grant resource or the downlink grant resource configured by the network device. Alternatively, the terminal device may receive at least one of the uplink grant resource or the downlink grant resource from the network device through a Radio Resource Control (RRC) message or other messages.

In a case where the terminal device needs to perform transmission, the required resource for the transmission may be determined. Further, the required resource is compared with the resource granted by the network device for the terminal device. In a case where the required resource for the transmission is less than the resource granted by the network device for the terminal device, the transmission may be directly performed. However, in a case where the required resource for the transmission exceeds the resource granted by the network device for the terminal device, it may be determined that the grant resource configured by the network device is insufficient.

S502: the measurement reconfiguration message is transmitted to the terminal device, where the measurement reconfiguration message includes the measurement event A7 for switching the cell.

In the embodiment of the present disclosure, the network device receives the indication information indicating that the resource is insufficient transmitted by the terminal device, meaning that the resource of the source serving cell currently accessed by the terminal device is insufficient. In order to enable the contact state between the terminal device and the network to be optimal, and then provide guarantee for the application of various network services, the terminal device needs to carry out cell switching in mobility management, that is to say, the terminal device completes the migration of the wireless link connection from the source serving cell to the target serving cell under the control of the wireless access network.

It is to be noted that the premise of cell switching is to measure the signal quality of the candidate serving cell of the terminal device. In the embodiment of the present disclosure, the network device may transmit the measurement reconfiguration message to the terminal device, so that the terminal device may re-measure the nearby cell. In the embodiment of the present disclosure, the measurement event A7 may be added to the measurement reconfiguration message, and the purpose of cell switching may be achieved through the measurement event A7. It is to be noted that the measurement event A7 is an event defined in the present disclosure, which is configured to measure the cells with the same frequency or different frequencies and measure the signal quality of a new cell to which the terminal device moves to a service bearer switching.

Alternatively, the measurement event A7 may include the condition that triggers the measurement report (MR), for example, may include the measurement object that needs to be measured in the serving cell and the candidate serving cell, and the relationship between the measurement value of the measurement object of the serving cell and the measurement value of the measurement object of the candidate serving cell.

Alternatively, the measurement object may include at least one of the RSRP, the RSRQ or the SINR of the cell.

It is to be noted that the premise of cell switching is to measure the signal quality of the source serving cell and the candidate serving cell of the terminal device. After receiving the measurement reconfiguration message, the terminal device may re-measure the signal quality of the source serving cell and the candidate serving cell based on the measurement reconfiguration message, to select a target serving cell with better signal quality for the terminal device from the candidate serving cell.

In the embodiment of the present disclosure, in response to determining that at least one of the uplink grant resource or the downlink grant resource is insufficient, the indication information may be transmitted to the network device, and the measurement reconfiguration message transmitted by the network device may be received. The measurement reconfiguration message includes the measurement event A7 for switching the cell. In the embodiment of the present disclosure, the network device retransmits the measurement reconfiguration message through the indication information indicating that the resource is insufficient, so that the terminal device can perform re-measurement quickly, which may solve the problem that re-measurement cannot be performed due to the insufficient resource though the quality of the terminal device is good, provide a basis for the terminal device to switch the cell in the next step, and avoid the problem that the terminal device is in a hanging state.

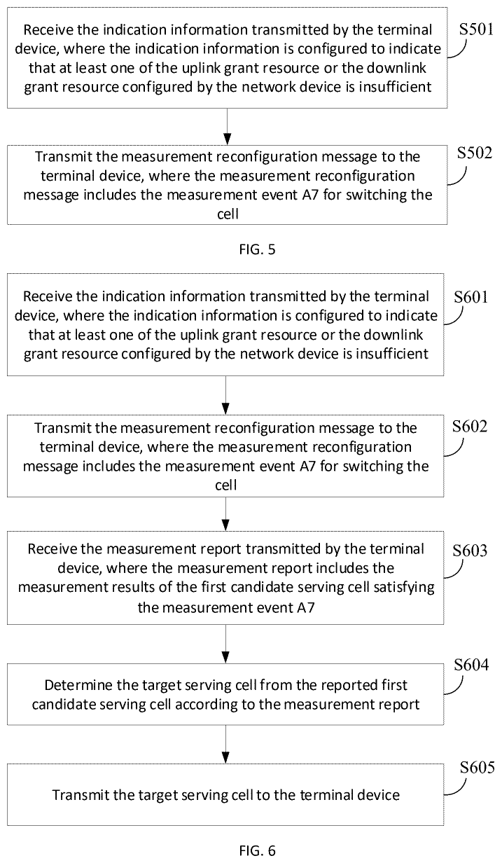

Refer to FIG. 6, which is a flowchart of a method of transmitting the measurement reconfiguration message according to an embodiment of the present disclosure. The method of transmitting the measurement reconfiguration message is performed by the network device, as shown in FIG. 6. The method includes but is not limited to the following steps.

S601: the indication information transmitted by the terminal device is received, where the indication information is configured to indicate that at least one of the uplink grant resource or the downlink grant resource configured by the network device is insufficient.

S602: the measurement reconfiguration message is transmitted to the terminal device, where the measurement reconfiguration message includes the measurement event A7 for switching the cell.

In some implementations, the network device may receive the indication information transmitted by the terminal device through the ASN.1 message body. Alternatively, in response to determining that at least one of the uplink grant resource or the downlink grant resource is insufficient, the terminal device configures a value of the indication information as a set value, adds the indication information to the ASN.1 message body, and transmits the ASN.1 message body to the network device. For example, the indication information may be no grant IE. The value of the indication information may be set to true.

Correspondingly, the network device may read the indication information from the ASN.1message body, and may transmit the measurement reconfiguration message to the terminal device in a case where the indication information is a set value.

As an alternative implementation, the measurement event A7 in the measurement reconfiguration message may include:
first measurement values of at least two measurement objects from the RSRP, the RSRQ and the SINR of the source serving cell need to be less than second measurement values of at least two measurement objects of the candidate serving cell.

As an alternative implementation, the measurement event A7 in the measurement reconfiguration message may include:
first measurement values of at least two measurement objects from the RSRP, the RSRQ and the SINR of the source serving cell need to be less than respective sum values of the respective second measurement values of the at least two measurement objects of the candidate serving cell and the respective offsets.

It is to be noted that at least two measurement objects of the source serving cell need to be the same as at least two measurement objects of the candidate serving cell. That is to say, if at least two measurement objects of the source serving cell are the RSRP and the RSRQ, at least two measurement objects of the candidate serving cell also need to be the RSRP and the RSRQ. If at least two measurement objects of the source serving cell are the RSRP and the SIRN, at least two measurement objects of the candidate serving cell also need to be the RSRP and the SIRN. If at least two measurement objects of the source serving cell are the RSRQ and the SIRN, at least two measurement objects of the candidate serving cell also need to be the RSRQ and the SIRN.

S603: the measurement report transmitted by the terminal device is received, where the measurement report includes the measurement result of the first candidate serving cell satisfying the measurement event A7.

In the embodiment of the present disclosure, there may be one or more candidate serving cells of the terminal device. Alternatively, the network device may configure the candidate serving cell to the terminal device.

After measuring the candidate serving cell, the terminal device may obtain the measurement result of the candidate serving cell. The measurement result may indicate the signal strength or the quality of the candidate serving cell. Alternatively, the network device may receive the measurement report transmitted by the terminal device, where the measurement report includes the cell ID of the first candidate serving cell satisfying the measurement event A7 and the measurement result corresponding to the first candidate serving cell. In some implementations, the network device may receive the cell ID of each first candidate serving cell satisfying the measurement event A7 and the measurement result corresponding to each first candidate serving cell transmitted by the terminal device. In other implementations, the network device may receive the first candidate serving cell satisfying the measurement event A7 selected by the terminal device according to the measurement result. Alternatively, the measurement result of the selected candidate serving cell needs to satisfy the preset condition. For example, the candidate serving cells received by the network device are some candidate serving cells with good quality, and the terminal device transmits the cell IDs of the candidate serving cells with good quality and measurement results corresponding to the candidate serving cells to the network device, to reduce signaling overhead and save resources.

S604: the target serving cell is determined from the reported first candidate serving cell according to the measurement report.

After the terminal device reports the first candidate serving cell satisfying the measurement event A7 and the measurement result of the first candidate serving cell to the network device, the network device may select the candidate serving cell satisfying the switching condition as the target serving cell from the reported first candidate serving cell based on the reported measurement result. For example, the switching condition may include that the cell quality satisfies the requirement and the cell is in an idle state.

S605: the target serving cell is transmitted to the terminal device.

The network device determines the cell switching instruction according to the target serving cell and indicates the cell switching instruction to the terminal device. Correspondingly, the terminal device receives the cell switching instruction transmitted by the network device, and the cell switching instruction includes the cell ID, the index or the ID offset of the target serving cell. Alternatively, the network device may transmit the cell switching instruction to the terminal device through the RRC, the DCI or the MAC-CE signaling.

Correspondingly, after receiving the cell switching instruction, the terminal device may determine the target serving cell that the terminal device needs to access for switching. The terminal device and the network device perform an information interaction process for switching the cell, to achieve the switching from the source serving cell currently accessed by the terminal device to the target serving cell.

In the embodiment of the present disclosure, the network device retransmits the measurement reconfiguration message through the indication information indicating that the resource is insufficient, so that the terminal device can perform re-measurement quickly, which may solve the problem that re-measurement cannot be performed due to the insufficient resource though the quality of the terminal device is good, provide a basis for the terminal to switch the cell in the next step, and avoid the problem that the terminal device is in a hanging state. Further, the insufficient resource may be quickly indicated to the network device, so that the network device can quickly determine the target serving cell of the terminal device, reduce the switching delay, improve the mobility performance, enable the contact state between the terminal device and the network to be always optimal, and further provide guarantee for the application of various network services.

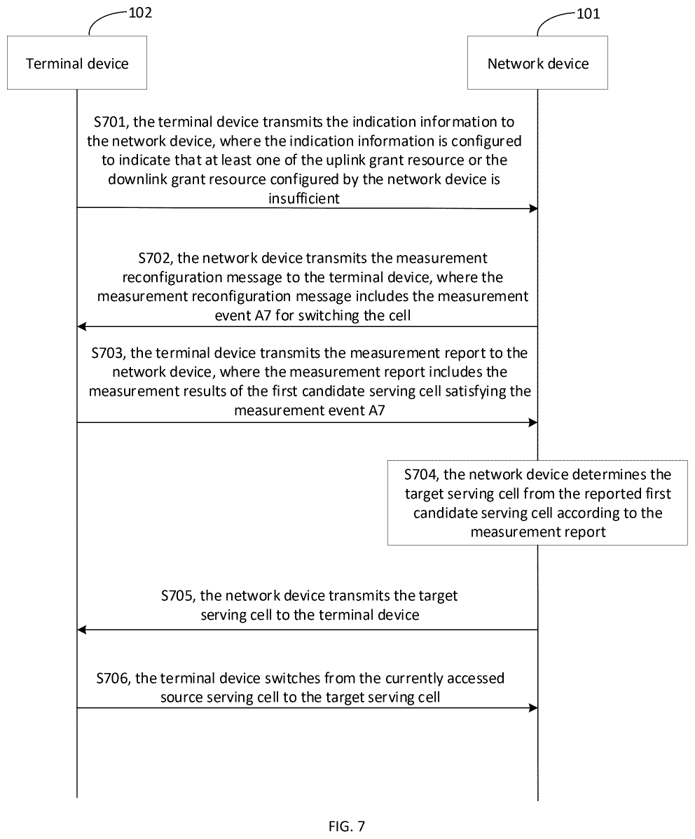

Refer to FIG. 7, which is a flowchart of a method of transmitting the measurement reconfiguration message according to an embodiment of the present disclosure. As shown in FIG. 7, the method includes but is not limited to the following steps.

S701: the terminal device transmits the indication information to the network device, where the indication information is configured to indicate that at least one of the uplink grant resource or the downlink grant resource configured by the network device is insufficient

S702: the network device transmits the measurement reconfiguration message to the terminal device, where the measurement reconfiguration message includes the measurement event A7 for switching the cell.

S703: the terminal device transmits the measurement report to the network device, where the measurement report includes the measurement result of the first candidate serving cell satisfying the measurement event A7.

S704: the network device determines the target serving cell from the reported first candidate serving cell according to the measurement report.

S705: the network device transmits the target serving cell to the terminal device.

S706: the terminal device switches from the currently accessed source serving cell to the target serving cell.

In the embodiment of the present disclosure, the network device retransmits the measurement reconfiguration message through the indication information, so that the terminal device can perform re-measurement, which provides a basis for the terminal device to perform cell in the next step. Further, the insufficient resource may be quickly indicated to switch the network device, so that the network device can quickly determine the target serving cell of the terminal device, reduce the switching delay, improve the mobility performance, enable the contact state between the terminal device and the network to be always optimal, and further provide guarantee for the application of various network services.

In the above embodiment provided by the present disclosure, the method according to the embodiment of the present disclosure is introduced from the perspectives of the network device and the terminal device, respectively. In order to achieve the functions in the method according to the embodiment of the present disclosure, the network device and the first terminal device may include a hardware structure and a software module. The above functions are achieved in the form of the hardware structure, the software module, or both the hardware structure and the software module. A certain function of the above functions may be implemented in the form of the hardware structure, the software module, or both the hardware structure and the software module.

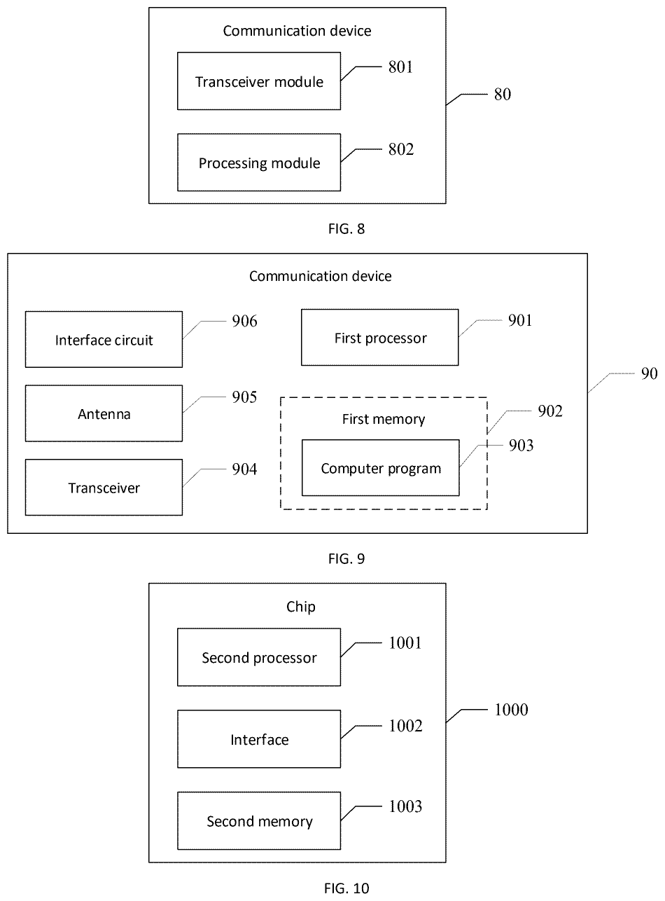

Refer to FIG. 8, which is a schematic structural diagram of a communication device 80 according to an embodiment of the present disclosure. The communication device 80 shown in FIG. 8 may include a transceiver module 801 and a processing module 802. The transceiver module 801 may include a transmitting module and/or a receiving module. The transmitting module is configured to achieve a transmitting function, the receiving module is configured to achieve a receiving function, and the transceiver module 801 may achieve the transmitting function and/or the receiving function.

The communication device 80 may be the terminal device, a device in the terminal device, or a device that can be used in conjunction with the terminal device. Alternatively, the communication device 80 may be the network device, a device in the network device, or a device that may be used in conjunction with the network device.

The communication device 80 is the terminal device.

the transceiver module 801 is configured to transmit indication information to a network device, where the indication information is configured to indicate that at least one of an uplink grant resource or a downlink grant resource configured by the network device is insufficient; and receive a measurement reconfiguration message transmitted by the network device, where the measurement reconfiguration message includes a measurement event A7 for switching a cell.

Alternatively, the transceiver module 801 is further configured to transmit a measurement report to the network device, where the measurement report includes a measurement result of the first candidate serving cell; and receive a target serving cell transmitted by the network device, where the target serving cell is determined from the first candidate serving cell according to the measurement report.

Alternatively, the processing module 802 is configured to switch from a currently accessed source serving cell to the target serving cell.

Alternatively, the processing module 802 is further configured to determine first measurement values of at least two measurement objects from a reference signal received power (RSRP), a reference signal receiving quality (RSRQ) and a signal to interference plus noise ratio (SINR) of the source serving cell; determine respective second measurement values of at least two measurement objects from an RSRP, an RSRQ and an SINR of the candidate serving cell of the terminal device, where the at least two measurement objects of the candidate serving cell are the same as the at least two measurement objects of the source serving cell; and determine the candidate serving cell satisfies the measurement event A7 in a case where the first measurement values of the at least two measurement objects are less than the respective second measurement values.

Alternatively, the processing module 802 is further configured to determine first measurement values of at least two measurement objects from an RSRP, an RSRQ and an SINR of the source serving cell; determine respective second measurement values of at least two measurement objects from the RSRP, the RSRQ and the SINR of the candidate serving cell of the terminal device, where the at least two measurement objects of the candidate serving cell are the same as the at least two measurement objects of the source serving cell; obtain respective sum values of the respective second measurement values of the at least two measurement objects and respective offsets; and determine the candidate serving cell satisfies the measurement event A7 in a case where the first measurement values of the at least two measurement objects are less than the respective sum values.

Alternatively, the transceiver module 801 is further configured to transmit the indication information to the network device through an abstract syntax notation one (ASN.1) message body.

Alternatively, the transceiver module 801 is further configured to configure a value of the indication information as a set value, add the indication information to the ASN.1 message body and transmit the ASN.1 message body to the network device.

Alternatively, the transceiver module 801 is further configured to receive at least one of the uplink grant resource or the downlink grant resource configured by the network device, and transmit the indication information to the network device through the ASN.1 message body, in a case where at least one of the uplink grant resource or the downlink grant resource is less than a required resource.

Alternatively, the processing module 802 is further configured to determine the required resource of the terminal device.

The communication device 80 is a communication device.

The transceiver module 801 is configured to receive indication information transmitted by a terminal device, where the indication information is configured to indicate that at least one of an uplink grant resource or a downlink grant resource configured by the network device is insufficient; and transmit a measurement reconfiguration message to the terminal device, where the measurement reconfiguration message includes a measurement event A7 for switching a cell.

Alternatively, the transceiver module 801 is further configured to receive a measurement report transmitted by the terminal device, where the measurement report includes a measurement result of a first candidate serving cell satisfying the measurement event A7; and transmit a target serving cell to the terminal device.

Alternatively, the processing module 802 is configured to determine the target serving cell from the first candidate serving cell according to the measurement report.

Alternatively, the measurement event A7 includes: first measurement values of at least two measurement objects from the RSRP, the RSRQ and the SINR of the source serving cell are less than respective second measurement values of the at least two measurement objects of the candidate serving cell.

Alternatively, the measurement event A7 includes: first measurement values of at least two measurement objects from the RSRP, the RSRQ and the SINR of the source serving cell are less than respective sum values of respective second measurement values of the at least two measurement objects of the candidate serving cell and respective offsets.

Alternatively, the transceiver module 801 is further configured to receive the indication information transmitted by the terminal device through an ASN.1 message body.

Alternatively, the processing module 802 is further configured to read the indication information from the ASN.1 message body, and determine a value of the indication information as a set value.

Alternatively, the transceiver module 801 is further configured to transmit at least one of the uplink grant resource or the downlink grant resource to the terminal device.

In the embodiment of the present disclosure, the network device retransmits the measurement reconfiguration message through the indication information indicating that the resource is insufficient, so that the terminal device can perform re-measurement quickly, which may solve the problem that re-measurement cannot be performed due to the insufficient resource though the quality of the terminal device is good, provide a basis for the terminal device to switch the cell in the next step, and avoid the problem that the terminal device is in a hanging state. Further, the insufficient resource may be quickly indicated to the network device, so that the network device can quickly determine the target serving cell of the terminal device, reduce the switching delay, improve the mobility performance, enable the contact state between the terminal device and the network to be always optimal, and further provide guarantee for the application of various network services.

Refer to FIG. 9, which is a schematic structural diagram of another communication device 90 according to an embodiment of the present disclosure. The communication device 90 may be a network device, a terminal device, or a chip, a chip system, or a processor that supports the network device to achieve the above method, or a chip, a chip system, or a processor that supports the terminal device to achieve the above method. The device may be configured to achieve the method described in the above method embodiment, as may be described in the above method embodiment.

The communication device 90 may include one or more first processors 901. The first processor 901 may be a general-purpose processor or a special-purpose processor, etc. For example, the processor may be a baseband processor or a central processor. The baseband processor may be configured to process a communication protocol and communication data. The central processor may be configured to control the communication device (such as a base station, a baseband chip, a terminal device, a terminal device chip, a DU or a CU, etc.), execute a computer program, and process data of the computer program.

Alternatively, the communication device 90 may further include one or more first memories 902 in which a computer program 903 may be stored. The first processor 901 executes the computer program 903, so that the communication device 90 may perform the method described in the above method embodiment. Alternatively, data may also be stored in the first memory 902. The communication device 90 and the first memory 902 may be provided separately or integrated together.

Alternatively, the communication device 90 may further include a transceiver 904 and an antenna 905. The transceiver 904 may be referred to as a transceiving unit, a transceiving machine or a transceiving circuit, and is configured to achieve a transceiving function. The transceiver 904 may include a receiver and a transmitter. The receiver may be referred to as a receiving machine or a receiving circuit, and is configured to achieve a receiving function. The transmitter may be referred to as a transmitting machine or a transmitting circuit, and is configured to achieve a transmitting function.

Alternatively, the communication device 90 may further include one or more interface circuits 906. The interface circuit 906 is configured to receive a code instruction and transmit the code instruction to the first processor 901. The first processor 901 operates the code instruction to cause the communication device 90 to perform the method described in the above method embodiment.

The communication device 90 is a terminal device for achieving the functions of the terminal device in the above embodiment.

The communication device 90 is a network device for achieving the functions of the network device in the above embodiment.

In an implementation, the first processor 901 may include a transceiver for achieving the receiving function and the transmitting function. For example, the transceiver may be a transceiving circuit, or an interface, or an interface circuit. The transceiving circuit, the interface or the interface circuit for achieving the receiving function and the transmitting function may be separated or integrated together. The transceiving circuit, the interface or the interface circuit may be configured to read and write codes/data. Alternatively, the transceiving circuit, the interface or the interface circuit may be configured to transmit or deliver signals.

In an implementation, the first processor 901 may store a computer program 903. The computer program 903, when operating on the first processor 901, may cause the communication device 90 to perform the method described in the above method embodiment. The computer program 903 may be solidified in the first processor 901, in which case, the first processor 901 may be implemented by hardware.

In an implementation, the communication device 90 may include a circuit, which may achieve the transmitting or receiving or communicating function in the above method embodiment. The processor and transceiver described in the present disclosure may be implemented on an Integrated Circuit (IC), an analog IC, a Radio Frequency Integrated Circuit (RFIC), a mixed-signal IC, an Application Specific Integrated Circuit (ASIC), a Printed Circuit Board (PCB), an electronic device, etc. The processor and the transceiver may also be manufactured by various IC process technologies, such as a Complementary Metal Oxide Semiconductor (CMOS), an N-Metal-Oxide-Semiconductor (NMOS), a Positive Channel Metal Oxide Semiconductor (PMOS), a Bipolar Junction Transistor (BJT), a bipolar CMOS (BiCMOS), silicon germanium (SiGe), gallium arsenide (GaAs), etc.

The communication device described in the above embodiment may be a network device or terminal device, but the scope of the communication device described in the present disclosure is not limited to this. Moreover, the structure of the communication device may not be limited by FIG. 9. The communication device may be an independent device or may be a part of a larger device. For example, the communication device may be:
(1) an independent integrated circuit (IC), or a chip, or a chip system or a subsystem; (2) a set with one or more ICs, in which alternatively, the IC set may further include storage components for storing data and computer programs; (3) an ASIC, such as a modem; (4) a module that may be embedded in other devices; (5) a receiving machine, a terminal device, an intelligent terminal device, a cellular phone, a wireless device, a handset, a mobile unit, a vehicle-mounted device, a network device, a cloud device, an artificial intelligence device, etc.; and (6) miscellaneous.

When the communication device may be a chip or a chip system, refer to the schematic structural diagram of a chip 1000 shown in FIG. 10. The chip shown in FIG. 10 includes a second processor 1001 and an interface 1002. There may be one or more first processors 901, and there may be a plurality of interfaces 1002.

The case that the chip is configured to achieve the functions of the terminal device in the embodiment of the present disclosure is as follows.

The interface 1002 is configured to transmit indication information to a network device, where the indication information is configured to indicate that at least one of an uplink grant resource or a downlink grant resource configured by the network device is insufficient; and receive a measurement reconfiguration message transmitted by the network device, where the measurement reconfiguration message includes a measurement event A7 for switching a cell.

Alternatively, the interface 1002 is further configured to transmit a measurement report to the network device, where the measurement report includes a measurement result of the candidate serving cell of the terminal device satisfying the measurement event A7; and receive a target serving cell transmitted by the network device, where the target serving cell is determined from the first candidate serving cell according to the measurement report.

Alternatively, the second processor 1001 is configured to switch from a currently accessed source serving cell to the target serving cell.

Alternatively, the second processor 1001 is further configured to determine first measurement values of at least two measurement objects from a reference signal received power (RSRP), a reference signal receiving quality (RSRQ) and a signal to interference plus noise ratio (SINR) of the source serving cell; determine respective second measurement values of at least two measurement objects from an RSRP, an RSRQ and an SINR of the candidate serving cell of the terminal device, where the at least two measurement objects of the candidate serving cell are the same as the at least two measurement objects of the source serving cell; and determine the candidate serving cell satisfies the measurement event A7 in a case where the first measurement values of the at least two measurement objects are less than the respective second measurement values.

Alternatively, the second processor 1001 is further configured to determine first measurement values of at least two measurement objects from an RSRP, an RSRQ and an SINR of the source serving cell; determine respective second measurement values of at least two measurement objects from the RSRP, the RSRQ and the SINR of the candidate serving cell of the terminal device, where the at least two measurement objects of the candidate serving cell are the same as the at least two measurement objects of the source serving cell; obtain respective sum values of the respective second measurement values of the at least two measurement objects and respective offsets; and determine the candidate serving cell satisfies the measurement event A7 in a case where the first measurement values of the at least two measurement objects are less than the respective sum values.

Alternatively, the interface 1002 is further configured to transmit the indication information to the network device through an abstract syntax notation one (ASN.1) message body.

Alternatively, the interface 1002 is further configured to configure a value of the indication information as a set value, add the indication information to the ASN.1 message body and transmit the ASN.1 message body to the network device.

Alternatively, the interface 1002 is further configured to receive at least one of the uplink grant resource or the downlink grant resource configured by the network device, and transmit the indication information to the network device through the ASN.1 message body, in a case where at least one of the uplink grant resource or the downlink grant resource is less than a required resource.

Alternatively, the second processor 1001 is further configured to determine the required resource of terminal device.

The case that the chip is configured to achieve the functions of the network device in the embodiment of the present disclosure is as follows.

The interface 1002 is configured to receive indication information transmitted by a terminal device, where the indication information is configured to indicate that at least one of an uplink grant resource or a downlink grant resource configured by the network device is insufficient; and transmit a measurement reconfiguration message to the terminal device, where the measurement reconfiguration message includes a measurement event A7 for switching a cell.

Alternatively, the interface 1002 is further configured to receive a measurement report transmitted by the terminal device, where the measurement report includes a measurement result of a first candidate serving cell satisfying the measurement event A7; and transmit a target serving cell to the terminal device.

Alternatively, the second processor 1001 is configured to determine the target serving cell from the first candidate serving cell according to the measurement report.

Alternatively, the measurement event A7 includes: first measurement values of at least two measurement objects from the RSRP, the RSRQ and the SINR of the source serving cell are less than respective second measurement values of the at least two measurement objects of the candidate serving cell.

Alternatively, the measurement event A7 includes: first measurement values of at least two measurement objects from the RSRP, the RSRQ and the SINR of the source serving cell are less than respective sum values of respective second measurement values of the at least two measurement objects of the candidate serving cell and respective offsets.

Alternatively, the interface 1002 is further configured to receive the indication information transmitted by the terminal device through an ASN.1 message body.

Alternatively, the second processor 1001 is further configured to read the indication information from the ASN.1 message body, and determine a value of the indication information as a set value.

Alternatively, the interface 1002 is further configured to transmit at least one of the uplink grant resource or the downlink grant resource to the terminal device.

Alternatively, the chip further includes a second memory 1003. The second memory 1003 is configured to store the required computer programs and data.

In the embodiment of the present disclosure, the network device retransmits the measurement reconfiguration message through the indication information indicating that the resource is insufficient, so that the terminal device can perform re-measurement quickly, which may solve the problem that re-measurement cannot be performed due to the insufficient resource though the quality of the terminal device is good, provide a basis for the terminal device to switch the cell in the next step, and avoid the problem that the terminal device is in a hanging state. Further, the insufficient resource may be quickly indicated to the network device, so that the network device can quickly determine the target serving cell of the terminal device, reduce the switching delay, improve the mobility performance, enable the contact state between the terminal device and the network to be always optimal, and further provide guarantee for the application of various network services.

Those skilled in the art may also understand that various illustrative logical blocks and steps listed in the embodiment of the present disclosure may be implemented by electronic hardware, computer software, or a combination of both. Whether this function is achieved by hardware or software depends on the specific application and the design requirements of the whole system. Those skilled in the art may use various methods to achieve the described functions for each specific application, which will not be understood to be beyond the scope of protection of the embodiment of the present disclosure.

An embodiment of the present disclosure further provides a communication system. The system includes a communication device as the terminal device and the communication device as the network device in the embodiment of FIG. 8 described above, or the system includes a communication device as the terminal device and the communication device as the network device in the embodiment of FIG. 9 described above.

The present disclosure further provides a non-transitory readable storage medium in which instructions are stored. The instructions, when executed by a computer, cause the computer to achieve the functions of any of the above method embodiments.

The present disclosure further provides a computer program product which, when executed by a computer, causes the computer to achieve the functions of any of the above method embodiments.

The above embodiments may be achieved in whole or in part by software, hardware, firmware or any combination of the same. When implemented by software, the above embodiments may be implemented in whole or in part in the form of a computer program product. The computer program product includes one or more computer programs. When the computer program is loaded and executed on a computer, the flows or functions according to the embodiment of the present disclosure are generated in whole or in part. The computer may be a general-purpose computer, a special-purpose computer, a computer network, or other programmable devices. The computer program may be stored in a non-transitory computer-readable storage medium or transmitted from a non-transitory computer-readable storage medium to another non-transitory computer-readable storage medium. For example, the computer program may be transmitted from a website, a computer, a server or a data center to another website, another computer, another server or another data center in a wired (such as a coaxial cable, an optical fiber, a Digital Subscriber Line (DSL)) or wireless (such as infrared, wireless, microwave, etc.) manner. The non-transitory computer-readable storage medium may be any available medium that a computer may access or a data storage device, such as a server, a data center and the like, which contains one or more available media integration. The available medium may be a magnetic medium (e.g., a floppy disk, a hard disk, a magnetic tape), an optical medium (e.g., a high-density Digital Video Disc (DVD)), or a semiconductor medium (e.g., Solid State Disk (SSD)), etc.

It is to be understood by those skilled in the art that the numerical numbers, such as first and second, involved in the present disclosure are merely for the convenience of description, rather than limit the scope of the embodiment of the present disclosure, which also indicate the sequence.

The term “at least one” in the present disclosure may also be described as one or more, and the term “a plurality of” may be two, three, four or more, which is not limited in the present disclosure. In the embodiment of the present disclosure, for a type of technical features, the technical features among this type of technical features are distinguished by “first”, “second”, “third”, “A”, “B”, “C” and “D”, and there is no sequence or size relationship between the technical features described by the “first”, “second”, “third”, “A”, “B”, “C” and “D”.

The corresponding relationship shown in each table in the present disclosure may be configured or predefined. The values of information in each table are mere examples, and may be configured as other values, which are not limited by the present disclosure. When configuring the corresponding relationship between information and parameters, not all the corresponding relationship shown in each table needs to be configured. For example, in the tables in the present disclosure, the corresponding relationship shown in some rows may not be configured. For another example, appropriate deformation and adjustment may be made based on the above tables, such as splitting, merging and so on. The names of the parameters indicated by the headings in the above tables may also be other names that may be understood by the communication device, and the values or representations of the parameters may also be other values or representations that may be understood by the communication device. Other data structures may also be used when the above tables are implemented, such as arrays, queues, containers, stacks, linear tables, pointers, linked lists, trees, graphs, structures, classes, piles, hash tables, etc.

Pre-definition in the present disclosure may be understood as definition, pre-definition, storage, pre-storage, pre-negotiation, pre-configuration, solidification, or pre-firing.

It may be appreciated by those skilled in the art that the units and algorithm steps of various examples described in conjunction with the embodiments disclosed herein can be implemented in electronic hardware, or a combination of computer software and electronic hardware. Whether these functions are implemented in hardware or software depends on the specific application and design constraints of the technical solution. Those skilled in the art may use different methods to achieve the described functions for each specific application, but this implementation is not to be considered to go beyond the scope of the present disclosure.

It may be clearly understood by those skilled in the art that for the convenience and conciseness of description, the specific working processes of the systems, devices and units described above may refer to the corresponding processes in the above method embodiments, which will not be described in detail here.

The above is mere the detailed description of the present disclosure, but the scope of protection of the present disclosure is not limited to this. Any changes or substitutions conceivable to those skilled in the art within the technical scope disclosed in the present disclosure are to be covered within the scope of protection of the present disclosure. Therefore, the scope of protection of the present disclosure will be based on the scope of protection of the claims.

1. A method of transmitting a measurement reconfiguration message, performed by a terminal device, comprising:
transmitting indication information to a network device, wherein the indication information is configured to indicate that at least one of an uplink grant resource or a downlink grant resource configured by the network device is insufficient; and
receiving the measurement reconfiguration message transmitted by the network device, wherein the measurement reconfiguration message comprises a measurement event A7 for switching a cell.

2. The method according to claim 1, wherein the method further comprises:
measuring a source serving cell currently accessed by the terminal device and a candidate serving cell of the terminal device;
determining whether there is a first candidate serving cell satisfying the measurement event A7 according to measurement results of the source serving cell and the candidate serving cell; and
transmitting a measurement report to the network device in a case where there is the first candidate serving cell that satisfies the measurement event A7, wherein the measurement report comprises a measurement result of the first candidate serving cell.

3. The method according to claim 2, wherein the method further comprises:
receiving a target serving cell transmitted by the network device, wherein the target serving cell is determined from the first candidate serving cell according to the measurement report; and
switching from the source serving cell currently accessed to the target serving cell.

4. The method according to claim 2, wherein the candidate serving cell satisfies the measurement event A7, comprising:
determining first measurement values of at least two measurement objects from a reference signal received power (RSRP), a reference signal receiving quality (RSRQ) and a signal to interference plus noise ratio (SINR) of the source serving cell;
determining respective second measurement values of at least two measurement objects from an RSRP, an RSRQ and an SINR of the candidate serving cell of the terminal device, wherein the at least two measurement objects of the candidate serving cell are the same as the at least two measurement objects of the source serving cell; and
determining the candidate serving cell satisfies the measurement event A7 in a case where the first measurement values of the at least two measurement objects are less than the respective second measurement values.

5. The method according to claim 2, wherein the candidate serving cell satisfies the measurement event A7, comprising:
determining first measurement values of at least two measurement objects from an RSRP, an RSRQ and an SINR of the source serving cell;
determining respective second measurement values of at least two measurement objects from an RSRP, an RSRQ and an SINR of the candidate serving cell of the terminal device, wherein the at least two measurement objects of the candidate serving cell are the same as the at least two measurement objects of the source serving cell;
obtaining respective sum values of the respective second measurement values of the at least two measurement objects and respective offsets; and
determining the candidate serving cell satisfies the measurement event A7 in a case where the first measurement values of the at least two measurement objects are less than the respective sum values.

6. The method according to claim 1, wherein transmitting indication information to the network device comprises:
transmitting the indication information to the network device through an abstract syntax notation one (ASN.1) message body.

7. The method according to claim 6, wherein transmitting the indication information to the network device through the abstract syntax notation one (ASN.1) message body comprises:
configuring a value of the indication information as a set value;
adding the indication information to the ASN.1 message body and transmitting the ASN.1 message body to the network device.

8. The method according to claim 6, wherein transmitting the indication information to the network device through the abstract syntax notation one (ASN.1) message body comprises:
receiving at least one of the uplink grant resource or the downlink grant resource configured by the network device;
determining a required resource of the terminal device; and
transmitting the indication information to the network device through the ASN.1 message body, in a case where at least one of the uplink grant resource or the downlink grant resource is less than the required resource.

9. A method of transmitting a measurement reconfiguration message, performed by a network device, comprising:
receiving indication information transmitted by a terminal device, wherein the indication information is configured to indicate that at least one of an uplink grant resource or a downlink grant resource configured by the network device is insufficient; and
transmitting the measurement reconfiguration message to the terminal device, wherein the measurement reconfiguration message comprises a measurement event A7 for switching a cell.

10. The method according to claim 9, wherein the method further comprises:
receiving a measurement report transmitted by the terminal device, wherein the measurement report comprises a measurement result of a first candidate serving cell satisfying the measurement event A7;
determining a target serving cell from the first candidate serving cell according to the measurement report; and
transmitting the target serving cell to the terminal device.

11. The method according to claim 10, wherein the measurement event A7 comprises:
first measurement values of at least two measurement objects from a reference signal received power (RSRP), a reference signal receiving quality (RSRQ) and a signal to interference plus noise ratio (SINR) of the source serving cell are less than respective second measurement values of at least two measurement objects of a candidate serving cell.

12. The method according to claim 10, wherein the measurement event A7 comprises:
first measurement values of at least two measurement objects from an RSRP, an RSRQ and an SINR of the source serving cell are less than respective sum values of respective second measurement values of at least two measurement objects of a candidate serving cell and respective offsets.

13. The method according to claim 9, wherein receiving indication information transmitted by the terminal device comprises:
receiving the indication information transmitted by the terminal device through an abstract syntax notation one (ASN.1) message body.

14. The method according to claim 13, wherein before transmitting the measurement reconfiguration message to the terminal device, the method further comprises:
reading the indication information from the ASN.1 message body; and
determining a value of the indication information as a set value.

15. The method according to claim 9, wherein the method further comprises:
transmitting at least one of the uplink grant resource or the downlink grant resource to the terminal device.

16.-17. (canceled)

18. A communication device, comprising: one or more processors and a memory, wherein the memory stores a computer program, and the computer program stored in the memory, when collectively executed by the one or more processors, causes the communication device to:
transmit indication information to a network device, wherein the indication information is configured to indicate that at least one of an uplink grant resource or a downlink grant resource configured by the network device is insufficient; and
receive a measurement reconfiguration message transmitted by the network device, wherein the measurement reconfiguration message comprises a measurement event A7 for switching a cell.

19. A communication device, comprising: one or more processors and a memory, wherein the memory stores a computer program, and the computer program stored in the memory, when collectively executed by the one or more processors, causes the communication device to perform the method according to claim 9.

20. A communication device, comprising: one or more processors and an interface circuit; wherein
the interface circuit is configured to receive code instructions and transmit the code instructions to the one or more processors; and
the one or more processors are configured to collectively execute the code instructions to perform the method according to claim 1.

21. A communication device, comprising: one or more processors and an interface circuit;
wherein the interface circuit is configured to receive code instructions and transmit the code instructions to the processor; and
the one or more processors are configured to collectively execute the code instructions to perform the method according to claim 9.

22. A non-transitory computer-readable storage medium storing instructions, wherein the instructions, when executed, implement the method according to claim 1.

23. (canceled)
